(19) United States
(12) Patent Application Publication
(10) Pub. No.: US 2013/0038183 A1
(43) Pub. Date: Feb. 14, 2013

(54) Driving Machine with Detachable Battery for Electric Garage Doors and Electric Rolling Doors

(71) Applicant: Shih-Fang Chen, Taoyuan City (TW)

(72) Inventor: Shih-Fang Chen, Taoyuan City (TW)

(73) Assignee: INNO DIGIC LIMITED, Taoyuan County (TW)

(21) Appl. No.: 13/209,174

(22) Filed: Aug. 12, 2011

(51) Int. Cl. H02K 7/10

(52) U.S. Cl. 310/75 R

(57) ABSTRACT

The present invention discloses a driving machine with a detachable battery for electric garage doors and electric rolling doors, which is electrically driven to open or close an electric garage door or electric rolling door, and which comprises a driving device and a spare power device. The spare power device can be detachably assembled to and electrically connected with the driving device. The spare power device has a rechargeable battery, which provides the driving device with power required to open or close the electric garage door or electric rolling door in electric outage.

### BACKGROUND OF THE INVENTION

1. Field of the Invention

The present invention relates to a driving machine with a detachable battery for electric garage doors and electric rolling doors, which can be controlled in a wired or wireless way to open or close an electric garage door or electric rolling door. The present invention particularly relates to a driving machine with a detachable battery for electric garage doors and electric rolling doors, which can be powered by a built-in spare power source to open or close an electric garage door or electric rolling door in electric outage.

2. Description of the Related Art

For safety and convenience, a house or factory usually has an electric rolling door or electric garage door. The electric garage door and electric rolling door are normally opened or closed by a driving machine. The conventional driving machine for electric garage doors and electric rolling door comprises a logic circuit board, a wireless receiver, and a motor. Once receiving a wireless signal, the driving machine drives the electric garage door or electric rolling door to open or close.

As a driving machine is powered by electricity, it cannot open or close the electric garage door or electric rolling door in electric outage. In such a case, the user has to operate the clutch to disconnect the electric garage door or electric rolling door from the driving machine so as to open or close the electric garage door or electric rolling door manually.

### SUMMARY OF THE INVENTION

The primary objective of the present invention is to provide a driving machine with a detachable battery for electric garage doors and electric rolling doors, wherein the battery can provide emergency electric power for the driving machine to open or close the electric garage door or electric rolling door in electric outage.

To achieve the abovementioned objective, the present invention proposes a driving machine with a detachable battery for electric garage doors and electric rolling doors, which comprises

A driving device; and

A spare power device assembled to and electrically connected with the driving device, detachable from the driving device, and having a rechargeable battery powering the driving device to open or close the electric rolling door.

In one embodiment, the driving device has a power device assembly seat for assembling and electrically connecting the spare power device to the driving device.

In one embodiment, the power device assembly seat and the spare power device respectively have an insert socket and an insert element adapted to the insert socket.

In one embodiment, the power device assembly seat has a fastening socket, and the spare power device has a fastening element. When the spare power device is assembled to the driving device, the fastening socket and the fastening element are locked to each other.

In one embodiment, the spare power device has a releasing element, which can actuate the fastening element to move to an unlock position, whereby the fastening element disengages from the fastening socket.

In one embodiment, the spare power device, which is assembled to the driving device, further comprises

A battery providing the driving device with power required to open or close the electric rolling door;

A battery bay receiving the battery; and

A cover assembled to the battery bay to accommodate the battery between them, and separable from the battery bay for replacing the battery.

In one embodiment, the power device assembly seat and the battery bay respectively have an insert socket and an insert element adapted to the insert socket.

In one embodiment, the power device assembly seat has a fastening socket, and the battery bay has a fastening element. When the spare power device is assembled to the driving device, the fastening socket and the fastening element are locked to each other.

In one embodiment, the battery bay has a releasing element, which can actuate the fastening element to move to an unlock position, whereby the fastening element disengages from the fastening socket.

### BRIEF DESCRIPTION OF THE DRAWINGS

FIG. 1 is a perspective view schematically showing the application of a driving machine with a detachable battery for electric garage doors and electric rolling doors according to one embodiment of the present invention;

FIG. 2 is a perspective view schematically showing a driving machine with a detachable battery in an assembled state according to one embodiment of the present invention;

FIG. 3 is a perspective view schematically showing a driving machine with a detachable battery in a disassembled state according to one embodiment of the present invention;

FIG. 4 is a perspective exploded view schematically showing a driving machine with a detachable battery for electric garage doors and electric rolling doors, wherein the spare power device is detached from the driving machine, and wherein the spare power device is disassembled, according to one embodiment of the present invention; and

FIG. 5 is a perspective view schematically showing a spare power device of a driving machine with a detachable battery from another view angle according to one embodiment of the present invention.

### DETAILED DESCRIPTION OF THE INVENTION

Below, the embodiments are described in detail to demonstrate the technical contents of the present invention.

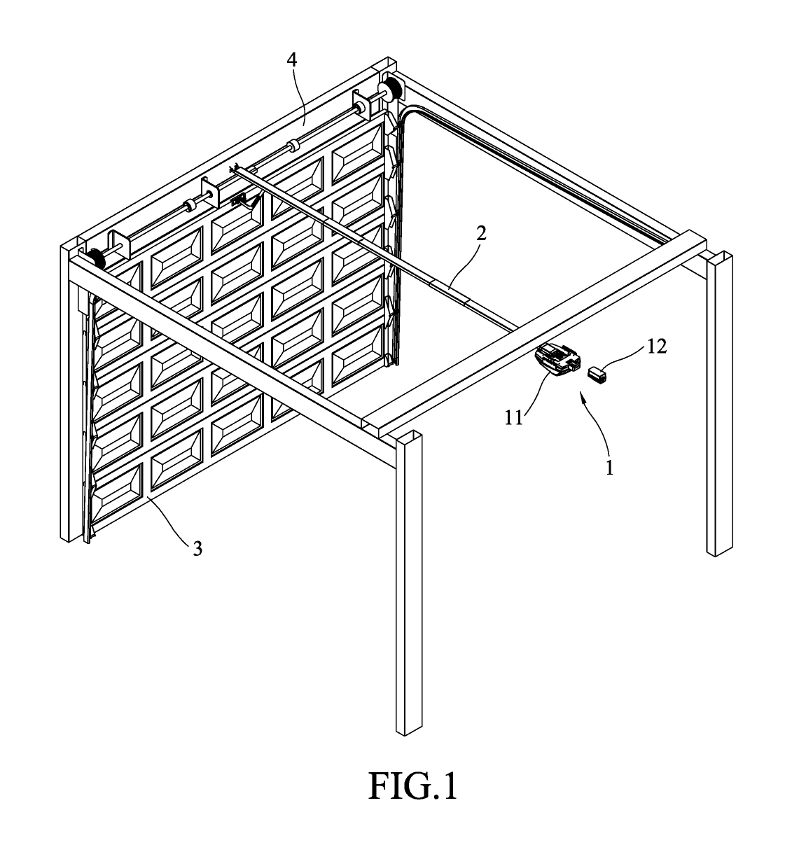

Refer to FIG. 1 a perspective view schematically showing a driving machine with a detachable battery for electric garage doors and electric rolling doors according to one embodiment of the present invention. The driving machine 1 is arranged on one end of a guide rail 2. The other end of the guide rail 2 is connected with an electric rolling door (or an electric garage door) 3 and a wall 4. A driving chain or driving toothed belt, which connects with the driving machine 1 and the electric rolling door 3, is arranged inside the guide rail 2. When triggered by a remote controller or a switch, the driving machine 1 actuates the driving chain or driving toothed belt to drive the electric rolling door 3 to open or close.

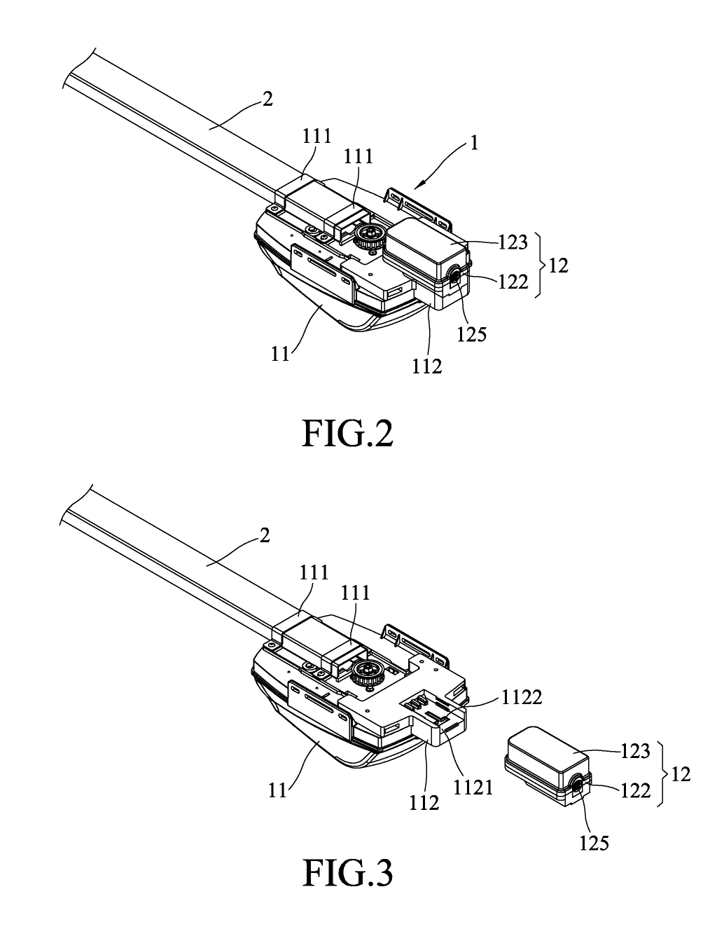

Refer to FIG. 2 and FIG. 3. The driving machine with a detachable battery for electric garage doors and electric rolling doors of the present invention comprises a driving device 11 and a spare power device 12 joined to and detachable from the driving device 11. The driving device 11 has a hanger 111 hanging the driving device 11 on the guide rail 2. The spare power device 12 is assembled to and electrically connected with the driving device 11.

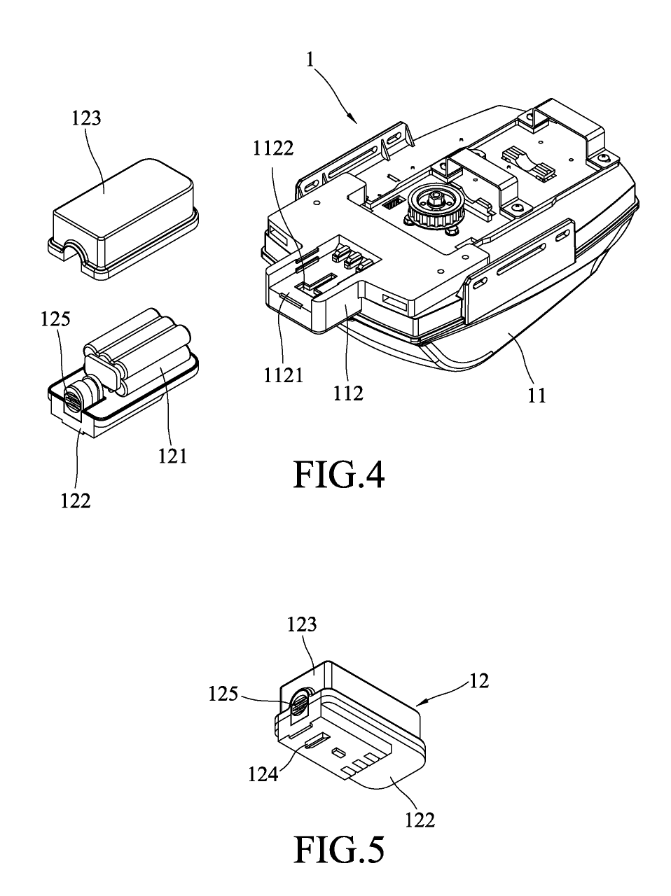

Refer to FIG. 4. The spare power device 12 includes a rechargeable battery 121 proving the driving device 11 with power required to open or close the electric rolling door 3; a battery bay 122 receiving the battery 121; and a cover 123 assembled to the upper side of the battery bay 122, whereby the battery 121 is accommodated between the cover 123 and the battery bay 122. The cover 123 is separable from the battery bay 122 for replacing the battery 121. The battery 121 can be discharged and recharged repeatedly.

Refer to FIG. 4 and FIG. 5. The driving device 11 has a power device assembly seat 112 for assembling the spare power device 12 to the driving device 11. The power device assembly seat 112 and the battery bay 122 respectively have an insert socket 1121 and an insert element 1221 adapted to the insert socket 1121. The power device assembly seat 112 has a fastening socket 1122, and the battery bay 122 has a fastening element 124, whereby the fastening element 124 is locked to the fastening socket 1122 when the spare power device 12 is assembled to the driving device 11.

The battery bay 122 also has a releasing element 125, which can actuate the fastening element 124 to move to an unlock position, whereby the fastening element 124 disengages from the fastening socket 1122, and whereby the battery bay 122 of the spare power device 12 is disassembled from the power device assembly seat 112.

The fastening element 124 and the releasing element 125 may be fabricated into two independent components or a one-piece component.

In conclusion, the present invention proposes a driving machine 1 with a spare power source for electric garage doors and electric rolling doors, wherein the driving machine 1 carries a spare power device 12 providing emergency power for the driving machine 1 to open or close the electric rolling door (or electric garage door) 3 when the commercial power is interrupted.

The embodiments described above are only to exemplify the present invention but not to limit the scope of the present invention. Any equivalent modification or variation according to the specification and claims of the present invention is to be also includes within the scope of the present invention.

What is claimed is:

1. A driving machine with a detachable battery for electric garage doors and electric rolling doors, which is electrically driven to open or close an electric garage door or an electric rolling door, comprising
a driving device; and
a spare power device detachably assembled to and electrically connected with said driving device and having a rechargeable battery providing said driving device with power required to open or close said electric garage door or said electric rolling door.

2. The driving machine with a detachable battery for electric garage doors and electric rolling doors according to claim 1, wherein said driving device has a power device assembly seat for assembling said spare power device to said driving device.

3. The driving machine with a detachable battery for electric garage doors and electric rolling doors according to claim 2, wherein said power device assembly seat and said spare power device respectively have an insert socket and an insert element adapted to said insert socket.

4. The driving machine with a detachable battery for electric garage doors and electric rolling doors according to claim 3, wherein said power device assembly seat and said spare power device respectively have a fastening socket and a fastening element, and wherein said fastening element is locked to said fastening socket when said spare power device is assembled to said driving device.

5. The driving machine with a detachable battery for electric garage doors and electric rolling doors according to claim 4, wherein said spare power device has a releasing element, which can actuate said fastening element to move to an unlock position to disengage said fastening element from said fastening socket.

6. A driving machine with a detachable battery for electric garage doors and electric rolling doors, which is electrically driven to open or close an electric garage door or an electric rolling door, comprising
a driving device; and
a spare power device detachably assembled to and electrically connected with said driving device and including a rechargeable battery providing said driving device with power required to open or close said garage door or said electric rolling door, a battery bay receiving said rechargeable battery, and a cover assembled to said battery bay, wherein said rechargeable battery is accommodated between said cover and said battery bay, and wherein said cover is separable from said battery bay for replacing said rechargeable battery.

7. The driving machine with a detachable battery for electric garage doors and electric rolling doors according to claim 0, wherein said driving device has a power device assembly seat for assembling said spare power device to said driving device.

8. The driving machine with a detachable battery for electric garage doors and electric rolling doors according to claim 7, wherein said power device assembly seat and said battery bay respectively have an insert socket and an insert element adapted to said insert socket.

9. The driving machine with a detachable battery for electric garage doors and electric rolling doors according to claim 8, wherein said power device assembly seat and said battery bay respectively have a fastening socket and a fastening element, and wherein said fastening element is locked to said fastening socket when said spare power device is assembled to said driving device.

10. The driving machine with a detachable battery for electric garage doors and electric rolling doors according to claim 9, wherein said battery bay has a releasing element, which can actuate said fastening element to move to an unlock position to disengage said fastening element from said fastening socket.
